(19) United States
(12) Patent Application Publication
(10) Pub. No.: US 2025/0315626 A1
(43) Pub. Date: Oct. 9, 2025

(54) TECHNIQUES FOR AUTOMATING TASKS USING LARGE LANGUAGE MODELS AND SOFTWARE AGENTS

(71) Applicant: Ally Financial Inc., Detroit, MI (US)

(72) Inventors: Harish NAIK, Phoenix, AZ (US); Dzmitry DUBARAU, Charlotte, NC (US); Jordan GILLIAM, Winston Salem, NC (US); Jared ALLMOND, Detroit, MI (US); Daniel LEMONT, Detroit, MI (US); Arvy RAJASEKARAN, Charlotte, NC (US); Sathish MUTHUKRISHNAN, Charlotte, NC (US)

(21) Appl. No.: 18/626,789

(22) Filed: Apr. 4, 2024

(51) Int. Cl. G06F 40/35; G06Q 10/10

(52) U.S. Cl. CPC G06F 40/35; G06Q 10/103

(57) ABSTRACT

A computing system may be used to support techniques to automate tasks using large language models (LLMs) and software agents. A user device may provide a data set to the computing system, and the computing system may process the data set to identify the one or more tasks using an LLM. The computing system may select one or more software agents to execute each of the identified tasks. For example, the computing system may identify a respective type for each task, and the computing system may select a respective software agent of a set of supported software agents configured to execute the respective type of task. Each software agent may execute a respective task to produce an output, such as by generating a summary of a transcript, transmitting one or more communications to users associated with the organization, or providing responses to inquiries, among other examples.

### FIELD OF TECHNOLOGY

The present disclosure relates generally to distributed systems and task management, and more specifically to techniques for automating tasks using large language models and software agents.

### BACKGROUND

An organization (e.g., a company, a corporation, a financial institution, or the like) may utilize multiple forms of communications to maintain multiple projects and support the success of the organization. For example, representatives of the organization may participate in meetings to discuss the status of projects, delegate tasks associated with projects, discuss and decide on various updates to projects, and so on. Additionally, a representative of an organization may communicate with a customer, for example, to discuss updates or other changes to a customer's account. In some cases, representatives may manually keep track of tasks and updates to projects based on these discussions. Similarly, when tasks require the involvement of various representatives throughout the organization for completion, each responsible representative may need to be separately notified. However, such methods may be time-consuming and error prone, which may result in omitted or incorrect execution of tasks, may introduce security concerns associated with customer information, and so on. Further, such a method may be relatively expensive, as time and resources used to manage such tasks may be better suited for other purposes.

### SUMMARY

The described techniques relate to improved methods, systems, devices, and apparatuses that support techniques for automating tasks using large language models (LLMs) and software agents. Generally, the described techniques provide for identifying tasks associated with projects of an organization using a computing system that implements an LLM, and executing the tasks by configuring one or more custom software agents. For example, the computing system may be provided with a data set, such as a transcript of a meeting between representatives of the organization, or a transcript of a conversation between a representative of the organization and a customer. The computing system may determine one or more tasks by processing the data set, and the computing system may select a set of software agents to execute the one or more tasks based on identified types of the tasks.

A method is described. The method may include receiving, at a computing system implementing an LLM and associated with an organization, a data set associated with one or more projects of the organization, determining, using an application programming interface (API) library to provide the data set to the LLM, one or more tasks associated with each of the one or more projects, selecting one or more software agents for executing the one or more tasks based on determining the one or more tasks, the one or more software agents managed by the organization and selected from a database, where each software agent of the one or more software agents is configured for a respective type of tasks associated with the one or more tasks, and executing the one or more tasks using the selected one or more software agents.

An apparatus is described. The apparatus may include one or more memories and one or more processors coupled with the one or more memories. The one or more processors may be configured to cause the apparatus to receive, at a computing system implementing an LLM and associated with an organization, a data set associated with one or more projects of the organization, determine, using an API library to provide the data set to the LLM, one or more tasks associated with each of the one or more projects, select one or more software agents for executing the one or more tasks based on a determination of the one or more tasks, the one or more software agents managed by the organization and selected from a database, where each software agent of the one or more software agents is configured for a respective type of tasks associated with the one or more tasks, and execute the one or more tasks using the selected one or more software agents.

A non-transitory computer-readable medium storing code is described. The code may include instructions executable by one or more processors to receive, at a computing system implementing an LLM and associated with an organization, a data set associated with one or more projects of the organization, determine, using an API library to provide the data set to the LLM, one or more tasks associated with each of the one or more projects, select one or more software agents for executing the one or more tasks based on a determination of the one or more tasks, the one or more software agents managed by the organization and selected from a database, where each software agent of the one or more software agents is configured for a respective type of tasks associated with the one or more tasks, and execute the one or more tasks using the selected one or more software agents.

Some examples of the method, apparatus, and non-transitory computer-readable medium described herein may further include operations, features, means, or instructions for identifying the respective type of task associated with each task of the one or more tasks using a software orchestrator of the computing system, where selecting the one or more software agents includes associating each task of the one or more tasks with a respective software agent of the one or more software agents based on the respective type of task associated with each task.

Some examples of the method, apparatus, and non-transitory computer-readable medium described herein may further include operations, features, means, or instructions for storing metadata associated with the one or more projects to a database managed by the computing system.

In some examples of the method, apparatus, and non-transitory computer-readable medium described herein the data set includes a transcript of a meeting. Some examples of the method, apparatus, and non-transitory computer-readable medium described herein may further include operations, features, means, or instructions for determining the one or more tasks includes identifying the one or more tasks within the transcript using the LLM.

Some examples of the method, apparatus, and non-transitory computer-readable medium described herein may further include operations, features, means, or instructions for identifying, using the LLM, a first project of the one or more projects and a second project of the one or more projects, and associating, using the LLM, a first subset of the one or more tasks with the first project and a second subset of the one or more tasks with the second project.

Some examples of the method, apparatus, and non-transitory computer-readable medium described herein may further include operations, features, means, or instructions for determining, using the LLM, that a first representative of one or more representatives associated with the meeting corresponds to a first task of the one or more tasks, determining, using the LLM, that a second representative of the one or more representatives corresponds to a second task of the one or more tasks, and storing an indication that the first representative corresponds to the first task and the second representative corresponds to the second task based on the first representative corresponding to the first task and the second representative corresponding to the second task.

Some examples of the method, apparatus, and non-transitory computer-readable medium described herein may further include operations, features, means, or instructions for transmitting, using a software agent of the one or more software agents, a first message associated with the first task to the first representative and a second message associated with the second task to the second representative, refraining from transmitting the second message to the first representative, and refraining from transmitting the first message to the second representative.

In some examples of the method, apparatus, and non-transitory computer-readable medium described herein the data set includes a transcript of an interaction between a representative of the organization and a user of the organization. Some examples of the method, apparatus, and non-transitory computer-readable medium described herein may further include operations, features, means, or instructions for determining the one or more tasks includes identifying one or more updates to an account managed by the organization and associated with the user.

Some examples of the method, apparatus, and non-transitory computer-readable medium described herein may further include operations, features, means, or instructions for providing, by the computing system, an indication of the one or more updates to a software agent of the one or more software agents, and updating, by the software agent, one or more parameters of the account based on the indication of the one or more updates.

### BRIEF DESCRIPTION OF THE DRAWINGS

FIG. 1 shows an example of a system that supports techniques for automating tasks using large language models (LLMs) and software agents in accordance with one or more aspects of the present disclosure.

FIG. 2 shows an example of a system that supports techniques for automating tasks using LLMs and software agents in accordance with one or more aspects of the present disclosure.

FIG. 3 shows an example of a process flow that supports techniques for automating tasks using LLMs and software agents in accordance with one or more aspects of the present disclosure.

FIG. 4 shows a diagram of a system including a device that supports techniques for automating tasks using LLMs and software agents in accordance with one or more aspects of the present disclosure.

FIG. 5 shows a flowchart illustrating methods that support techniques for automating tasks using LLMs and software agents in accordance with one or more aspects of the present disclosure.

### DETAILED DESCRIPTION

An organization (e.g., a company, a corporation, a financial institution, or the like) may use multiple forms of communications to track and maintain multiple projects and support the success of the organization. For example, representatives of the organization may participate in meetings to discuss the status of projects, delegate tasks associated with projects, discuss and decide on various updates to projects, and so on. As part of those meetings, notes, transcripts, and other written records related to the projects, responsible parties, and/or topics discussed by the representatives may be obtained and stored in various types of documentation. In other examples, a representative of an organization may communicate with a customer to discuss updates or other changes to a customer's account. As part of such communications, a transcript of the conversation between the representative and the customer may be generated (e.g., by a computing system). In any case, representatives may manually keep track of tasks and updates to projects based on these discussions, and follow-on actions to be performed by the organization may be dependent on manual input by one or more representatives. However, such techniques may be time-consuming and error prone, and may result in omitted or incorrect execution of tasks, or may introduce security concerns associated with customer information, and so on. Further, such techniques may be relatively expensive, as both time and resources used to manage such tasks could be better suited for other purposes.

As described herein, a computing system may support automated task management using one or more artificial intelligence (AI) and/or machine learning (ML) platforms, models, and/or functionalities, such as a large language model (LLM). For example, a user may provide a data set to the computing system. The computing system may include one or more AI agents operable to process the data set to identify one or more tasks associated with one or more projects using the data set. For example, the AI agent may include or may interface with the LLM to provide the data set to the LLM, and the LLM may process the data sets to identify one or more tasks associated with the data sets. The computing system may configure the LLM to identify tasks associated with the data set, and may configure the LLM to output the tasks in accordance with a specified format.

The one or more AI agents may select one or more software agents to execute each of the identified tasks. For example, an AI agent may identify a respective type for each task and may select a respective software agent of a set of supported software agents configured to execute the respective type of task. Each software agent may execute a respective task to produce an output, such as by generating a summary of a transcript, transmitting one or more communications to users associated with the organization, or providing responses to inquiries, among other examples. By implementing the one or more AI agents, the organization may improve efficiency of projects of the organization, may improve accuracy and reliability of communications associated with projects of the organization, and may improve security of communications and updates associated with projects of the organization, among other benefits.

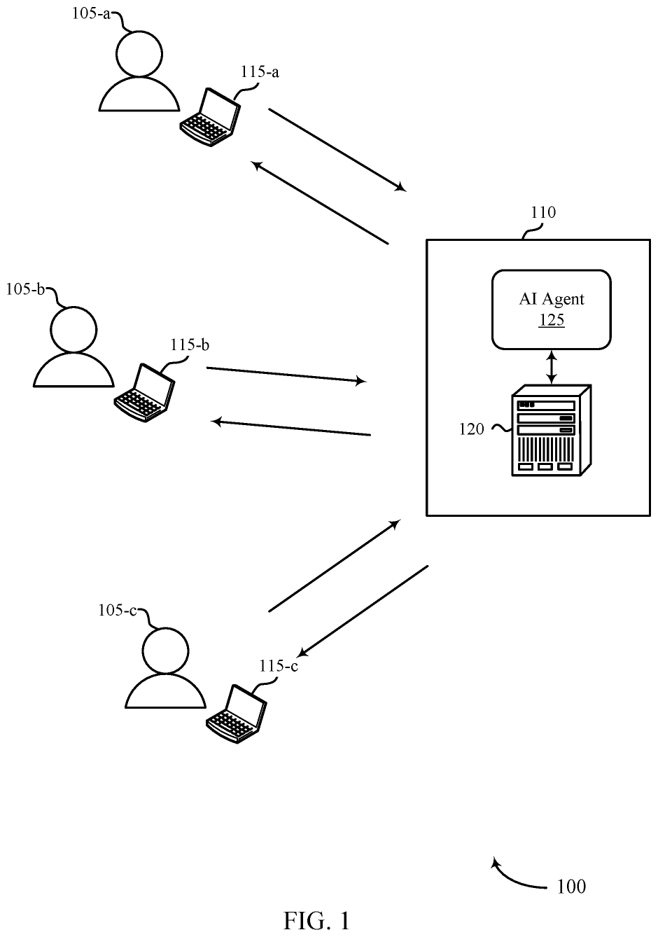

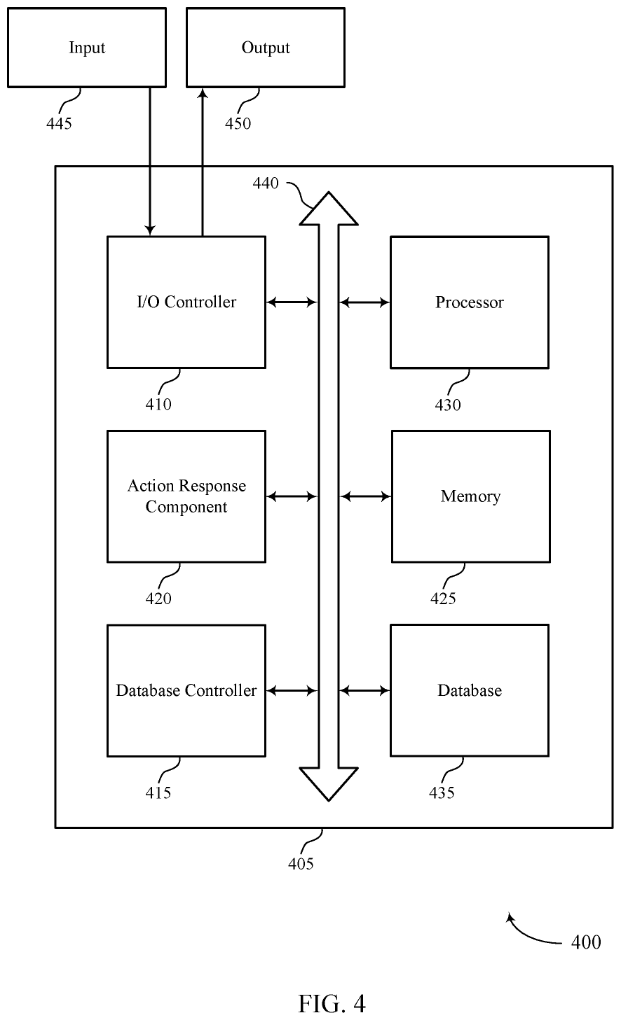

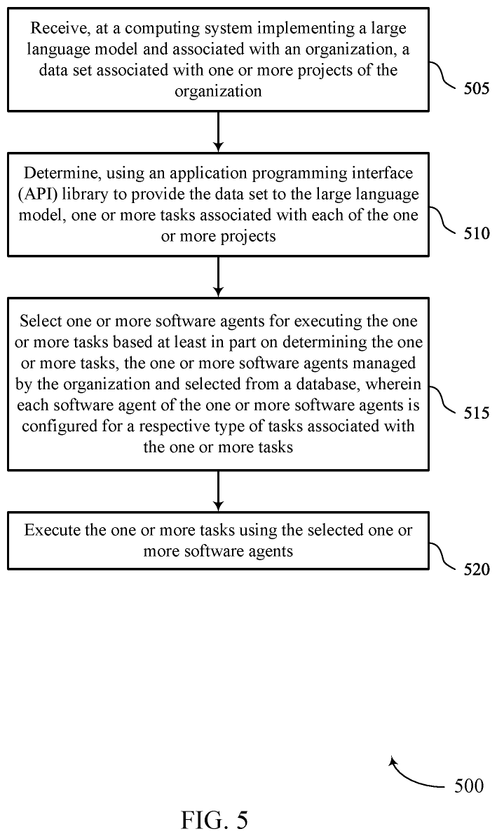

Aspects of the disclosure are initially described in the context of systems and process flows with reference to FIGS. 1 through 3. Aspects of the disclosure are further illustrated by and described with reference to systems and flowcharts that relate to techniques for verifying a sender identity using a user-generated identifier with reference to FIGS. 4 and 5.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally, or alternatively, solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 1 shows an example of a system 100 that supports techniques for automating tasks using LLMs and software agents in accordance with one or more aspects of the present disclosure. The system 100 may include one or more users 105 that may interact (e.g., via one or more user devices 115, applications, or the like) with a computing system 110 associated with an organization (a company, a bank, a corporation, a credit union, a lender, or the like) over a network, such as the Internet. A user 105 as described herein may be associated with a user device 115 (e.g., a desktop computer, a laptop, a smartphone, a tablet, or other computing system). Similarly, the computing system 110 described herein may be associated with one or more devices 120 (e.g., computers, servers, databases, or the like) and one or more programs (e.g., applications, functions, libraries, repositories, computer-executable code, or the like) that may be configured to implement aspects of the computing system 110.

One or more users 105 (e.g., a user 105-a, a user 105-b, and a user 105-c) may interact (e.g., via a device 115-a, a device 115-b, and a device 115-c) with the computing system 110 using an interface, which may support communications between a user device 115 and the computing system 110. For example, the interface may allow the user device 115 to transmit one or more messages (e.g., via the network) to the computing system 110, and may allow the computing system 110 to transmit one or more messages to the user device 115. In some examples, the interface may provide one or more prompts to the user device 115, and may allow the user 105 to enter information as a response to the prompts.

For example, a user device 115 may provide, via the interface, a data set to the computing system 110. The computing system 110 may include an AI agent 125 operable to process the data set to identify one or more tasks associated with one or more projects using the data set. For example, the AI agent 125 may include or may interface with an LLM. The AI agent 125 may provide the data set to the LLM (e.g., may input the data set to the LLM), and the LLM may process the data sets to identify one or more tasks associated with the data sets. An AI agent 125 may implement, utilize, or be associated with one or more ML algorithms, where an ML algorithm may be an example of a neural network, such as a feed forward (FF) or deep feed forward (DFF) neural network, a recurrent neural network (RNN), a long/short term memory (LSTM) neural network, or any other type of neural network. However, any other ML algorithms may be supported. For example, the ML algorithm may implement a nearest neighbor algorithm, a linear regression algorithm, a Naïve Bayes algorithm, a random forest algorithm, or any other ML algorithm. Further, ML processes associated with the AI agent 125 may involve supervised learning, unsupervised learning, semi-supervised learning, reinforcement learning, or any combination thereof. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

In some examples, the LLM may be an example of an ML system operable to receive one or more text inputs and generate a text output in response to the text inputs. The LLM may be an example of an artificial neural network and/or a deep learning algorithm, and the LLM may be used for various functions and operations including, for example, natural language processing, language generation, language summarization, and language prediction, to name a few. In some aspects, the LLM may utilize very large datasets (e.g., text data) and may be capable of comprehending human language text. The computing system 110 may configure the LLM to identify tasks associated with the data set, and may configure the LLM to output the tasks in accordance with a specified format. For example, the computing system 110 may configure the LLM to output a list or file that includes the one or more tasks, along with metadata associated with the tasks, such as a type of task for each of the tasks.

The AI agent 125 may select one or more software agents to execute each of the identified tasks. For example, the AI agent 125 may identify a respective type for each task, and may select a respective software agent of a set of supported software agents configured to execute the respective type of task. Each software agent may execute a respective task to produce an output, such as by generating a summary of a transcript, transmitting one or more communications to users 105 associated with the organization, or providing responses to inquiries, among other examples. By implementing the AI agent 125, the system 100 may improve efficiency of projects of the organization, may improve accuracy and reliability of communications associated with projects of the organization, and may improve security of communications and updates associated with projects of the organization, among other benefits.

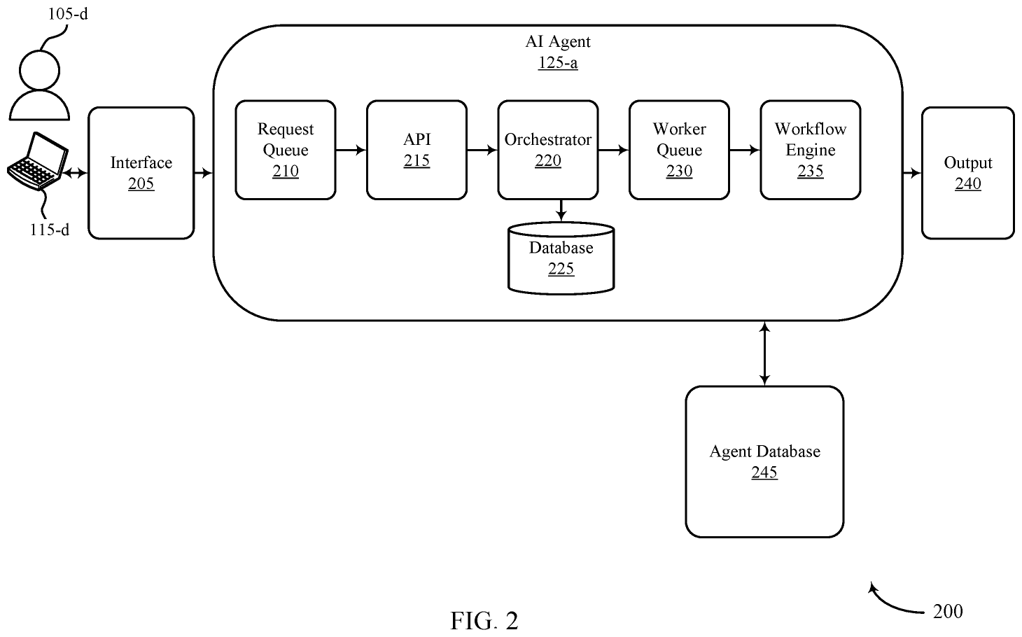

FIG. 2 shows an example of a system 200 that supports techniques for automating tasks using LLMs and software agents in accordance with one or more aspects of the present disclosure. The system 200 may include a user 105-d that may interact with an AI agent 125-a to identify and execute one or more tasks using a set of software agents. For example, the user 105-d may, using a user device 115-d, provide data set, such as a transcript of meeting between employees of an organization, a transcript of an interaction between a representative of an organization and a customer of the organization (e.g., a call transcript), one or more written communications (e.g., emails, electronic messages), or the like.

The AI agent 125-a may process the data set to identify the one or more tasks using an LLM. The AI agent 125-a may include an orchestrator 220 configured to select one or more software agents to execute each of the identified tasks. The orchestrator 220 may provide the selected software agents to a worker queue 230, which may initiate the software agents (e.g., according to an order within the worker queue 230, according to a priority of the software agents). Each software agent may execute a task to produce an output 240, such as by generating a summary of a transcript, transmitting one or more communications to users 105 associated with the system 200, providing responses to inquiries, among other examples. By implementing the AI agent 125-a, the system 200 may improve efficiency of projects of the organization, may improve accuracy and reliability of communications associated with projects of the organization, and may improve security of communications and updates associated with projects of the organization, among other benefits.

The device 115-d may interact with the AI agent 125-a using an interface 205. For example, the interface 205 may be an example of a user interface that includes an online portal, a website or application (e.g., a client-server application), a communication session between a device associated with the user 105-d and a device 120, or the like. In such examples, the user 105-d may upload one or more data sets to the AI agent 125-a via the interface 205. The interface 205 may provide (e.g., add, enqueue) the data sets and to a request queue 210.

In some cases, the interface 205 may support configuring metadata associated with a data set. For example, the user 105-d may specify one or more projects associated with the data set, may specify types of tasks that may be included in the data set, may specify security protocols or authentication information associated with the data set, or the like. By way of example, if a data set includes a transcript of a meeting, the configuring the metadata may include providing an indication of participants (e.g., employees, management personnel, counsel personnel) within the meeting. In some cases, configuring the metadata may include providing an indication to omit portions of the transcript, such as comments made by particular participants (e.g., legal counsel or other participants that may provide sensitive information).

The AI agent 125-a may process the data sets within the request queue using an application programming interface (API) library 215. For example, the API library 215 may transmit commands or messages to a server implementing the LLM (e.g., via an API call) and may receive communications to the server (e.g., as a response to the API call). The API library 215 may interface with an LLM (e.g., using one or more API calls) to process the data sets to determine one or more tasks associated with one or more projects of the organization. For example, the AI agent 125-a may input (via the API library 215) the data sets and, in some cases, metadata associated with the data sets to the LLM. The LLM may process the data sets to identify one or more tasks associated with the data sets, and may output the one or more tasks to the orchestrator 220.

By way of example, a data set may include a transcript of the meeting between one or more representative of an organization. In such examples, the LLM may parse the transcript to identify action items discussed during the meeting, employees to which action items are assigned, updates to the status of projects discussed in the meeting, identify scheduling information for the action items (e.g., deadlines, milestones), or the like. In some examples, the LLM may determine a type for each identified task (e.g., a task type), which may correspond to a respective category or classification of the task. Additionally, or alternatively, a data set may include a transcript of an interaction between a representative of the organization and a user of the organization, such as a transcript of a call concerning a customer's account. In such examples, the LLM may parse the transcript to identify action items associated with the customer's account, such as updates or other changes to the account.

In some cases, a data set may be associated with multiple projects. For example, if the data set includes transcript of a meeting between representative of the organization, the transcript may include tasks associated with a first project, a second project, or both. In such examples, the LLM may identify a respective one or more projects for each task, and may associate each task with a project, such as by generating and outputting metadata to indicate the association. For example, the LLM may associate a first task with the first project, may associate a second task with the second project, may associate a third task with both the first project and the second project, or a combination thereof.

In some cases, the LLM may determine that a data set does not contain sufficient information for a particular task. For example, if an action item is discussed in a meeting, but is not assigned to a particular employee, the LLM may identify that the task has not been assigned. In response to such a determination, the AI agent 125-a may transmit a request for additional information. For example, the AI agent 125-a may, via the interface 205, transmit a request to the device 115-d to supply the missing information. The user 105-d may provide the information to the AI agent 125-a via the interface 205, and the AI agent 125-a may associate the information with the task.

The orchestrator 220 may receive the set of tasks and may select a software agent for each task. For example, as part of processing the data sets, the LLM may identify a type for each task. The LLM may generate and output metadata indicating the type of each task to the orchestrator 220. The orchestrator 220 may use the indication of the type of the task to select a software agent for the task.

After selecting a set of software agents, the orchestrator 220 may provide the set of software agents to the worker queue 230. The worker queue 230 may initiate the set of software agents to execute the one or more tasks. For example, the worker queue 230 may initiate a software agent at a particular time associated with a task, such as initiating a software agent to transmit a reminder message to an employee at a time specified in metadata associated with the task. Additionally, or alternatively, the worker queue 230 may initiate the set of software agents sequentially, for example according to the order of the software agents within the worker queue 230.

After initiating a software agent, the worker queue 230 may provide the software agent to a workflow engine 235. The workflow engine 235 may support a software agent in executing the task associated with the software agent. For example, the workflow engine may manage and monitor aspects of a software agent, such as a state of a software agent, a completion status of a software agent, or the like. In some examples, the workflow engine 235 may be receive updates on the status of a task from a software agent. In such cases, the workflow engine 235 may provide an indication of the status to the device 115-d (e.g., via the interface 205).

Each software agent may execute an associated task to produce an output 240. By way of example, if a task includes providing a reminder to one or more representatives of the organization, the output 240 may include transmitting the reminder to the representatives. In some cases, the software agent may be configured to transmit different messages to different representatives (e.g., in accordance with metadata associated with the project). For example, the software agent may transmit a first message associated with the task to a first representatives, and may transmit a second message different than the first message to a second representatives. In such examples, the software agent may refrain from transmitting the first message to the second representative, and may refrain from transmitting the second message to the first representative. Additionally, or alternatively, a task may include updating aspects of a customer account. In such examples, a software agent may be configured with security permissions, and may update one or more parameters of the user account in accordance with metadata associated with the task.

In some cases, the AI agent 125-a may configure a software agent based on the type of task executed by the software agent. For example, the AI agent 125-a may configure a software agent with security permissions (e.g., authentication tokens, passwords, or the like) to allow the software agent to access, modify, and utilize secured aspects of an organization, such as customer information, database entries, email, or other communications, among other examples.

In some examples, the AI agent 125-a may include a database 225 to store information associated with projects of the organization. For example, the orchestrator 220 may update the database 225 to store metadata, such metadata extracted from the data set, metadata input by the user 105-d, or both. In some examples, the orchestrator 220 may update information within the database 225. For example, if the data set includes a change to a project, such as a change in the name of a project, a change to one or more teams associated with the project, or the like, the orchestrator 220 may update the metadata within the database 225 to reflect the change.

In some examples, the system 200 may include an agent database 245 operable to store one or more supported software agents. The agent database 245 may be an example of a database that may provide reliable and secure data storage for the system 100. In some cases, the contents of the agent database 245 may be updated (e.g., periodically updated). For example, a team (e.g., a developer team) associated with the organization may maintain the agent database 245. The team may build and store one or more software agents within the agent database 245. Such software agents may be built or developed in accordance with needs, processes, security policies of the organization, such as access policies, authorization credentials, access tokens, and the like.

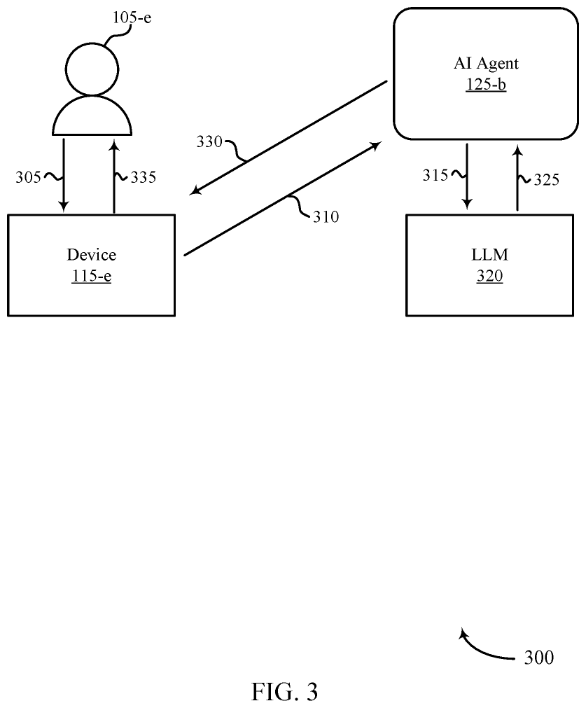

FIG. 3 shows an example of a process flow 300 that supports techniques for automating tasks using LLMs and software agents in accordance with one or more aspects of the present disclosure. The process flow 300 or aspects thereof may be implemented by a computing system associated with an organization (e.g., a computing system 110 as described with reference to FIG. 1) The computing system may provide functionality for, or support aspects of, a system managed by the organization. For example, the system may include or may implement an AI agent 125-b. In the following description of the process flow 300, the operations may be performed in a different order than the order shown. For example, specific operations may also be left out of the process flow 300, or other operations may be added to process flow 300.

The process flow 300 may illustrate a method to identify and execute one or more tasks using a set of software agents. For example, process flow 300 may illustrate a use case to automatically identify one or more tasks discussed in a transcript of a meeting between representatives of the organization. In some cases, following the meeting, a user 105-e may receive a message, such as an email, that includes an indication of the transcript. For example, the user 105-e may, via the user device 115-e at 305, receive a file that includes the transcript, or may receive a link (e.g., a hyperlink) that may be used to access the transcript. At 310, the AI agent 125-b may detect the message (e.g., the AI agent 125-b may monitor the email of the user 105-e) and retrieve the transcript.

At 315, the AI agent 125-b may process the transcript using an API library (e.g., the API library 215). For example, the AI agent 125-b may transmit commands or messages to a server implementing an LLM 320 (e.g., via an API call) and may, at 325, receive communications from the server (e.g., as a response to the API call). The AI agent 125-b may interface with the LLM 320 to process the data sets to determine one or more tasks associated with the transcript, such as action items discussed during the meeting, employees to which action items are assigned, updates to the status of projects discussed in the meeting, identify scheduling information for the action items (e.g., deadlines, milestones), or the like. In some examples, the AI agent 125-b may select one or more software agents to execute the tasks (e.g., based on respective types of the tasks).

The AI agent 125-b may execute the one or more tasks using the selected software agents. For example, if a task includes providing a reminder to one or more representatives, such as the user 105-e, the AI agent 125-b may, at 330, transmit the reminder to the user device 115-e and the user 105-e may, at 335, access the reminder via the user device 115-e. By implementing the AI agent 125-b, a computing system may improve efficiency of projects of the organization, may improve accuracy and reliability of communications associated with projects of the organization, and may improve security of communications and updates associated with projects of the organization, among other benefits.

FIG. 4 shows a diagram of a system 400 including a device 405 that supports techniques for automating tasks using LLMs and software agents in accordance with one or more aspects of the present disclosure. The device 405 may include components for bi-directional voice and data communications including components for transmitting and receiving communications, such as an action response component 420, an input/output (I/O) controller, such as an I/O controller 410, a database controller 415, at least one memory 425, at least one processor 430, and a database 435. These components may be in electronic communication or otherwise coupled (e.g., operatively, communicatively, functionally, electronically, electrically) via one or more buses (e.g., a bus 440).

The I/O controller 410 may manage input signals 445 and output signals 450 for the device 405. The I/O controller 410 may also manage peripherals not integrated into the device 405. In some cases, the I/O controller 410 may represent a physical connection or port to an external peripheral. In some cases, the I/O controller 410 may utilize an operating system such as iOS®, ANDROID®, MS-DOS®, MS-WINDOWS®, OS/2®, UNIX®, LINUX®, or another known operating system. Additionally, or alternatively, the I/O controller 410 may represent or interact with a modem, a keyboard, a mouse, a touchscreen, or a similar device. In some cases, the I/O controller 410 may be implemented as part of a processor. In some examples, a user may interact with the device 405 via the I/O controller 410 or via hardware components controlled by the I/O controller 410.

The database controller 415 may manage data storage and processing in a database 435. The database 435 may be external to the device 405, temporarily or permanently connected to the device 405, or a data storage component of the device 405. In some cases, a user may interact with the database controller 415. In some other cases, the database controller 415 may operate automatically without user interaction. The database 435 may be an example of a persistent data store, a single database, a distributed database, multiple distributed databases, a database management system, or an emergency backup database.

Memory 425 may include random-access memory (RAM) and read-only memory (ROM). The memory 425 may store computer-readable, computer-executable software including instructions that, when executed, cause the processor to perform various functions described herein. In some cases, the memory 425 may contain, among other things, a BIOS which may control basic hardware or software operation such as the interaction with peripheral components or devices.

The processor 430 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 430 may be configured to operate a memory array using a memory controller. In some other cases, a memory controller may be integrated into the processor 430. The processor 430 may be configured to execute computer-readable instructions stored in memory 425 to perform various functions (e.g., functions or tasks supporting techniques for automating tasks using LLMs and software agents).

For example, the action response component 420 may be configured as or otherwise support a means for receiving, at a computing system implementing a LLM and associated with an organization, a data set associated with one or more projects of the organization. The action response component 420 may be configured as or otherwise support a means for determining, using an API library to provide the data set to the LLM, one or more tasks associated with each of the one or more projects. The action response component 420 may be configured as or otherwise support a means for selecting one or more software agents for executing the one or more tasks based on determining the one or more tasks, the one or more software agents managed by the organization and selected from a database, where each software agent of the one or more software agents is configured for a respective type of tasks associated with the one or more tasks. The action response component 420 may be configured as or otherwise support a means for executing the one or more tasks using the selected one or more software agents.

FIG. 5 shows a flowchart illustrating a method 500 that supports techniques for automating tasks using LLMs and software agents in accordance with one or more aspects of the present disclosure. The operations of the method 500 may be implemented by a computing platform, such as a computing system 110 implementing an AI agent 125 as described with reference to FIGS. 1 through 4. In some examples, a computing platform may execute a set of instructions to control the functional elements of the computing platform to perform the described functions. Additionally, or alternatively, the computing platform may perform aspects of the described functions using special-purpose hardware.

At 505, the method may include receiving, at a computing system implementing a LLM and associated with an organization, a data set associated with one or more projects of the organization. The operations of 505 may be performed in accordance with examples as disclosed herein.

At 510, the method may include determining, using an API library to provide the data set to the LLM, one or more tasks associated with each of the one or more projects. The operations of 510 may be performed in accordance with examples as disclosed herein.

At 515, the method may include selecting one or more software agents for executing the one or more tasks based on determining the one or more tasks, the one or more software agents managed by the organization and selected from a database, where each software agent of the one or more software agents is configured for a respective type of tasks associated with the one or more tasks. The operations of 515 may be performed in accordance with examples as disclosed herein.

At 520, the method may include executing the one or more tasks using the selected one or more software agents. The operations of 520 may be performed in accordance with examples as disclosed herein.

In some examples, an apparatus as described herein may perform a method or methods, such as the method 500. The apparatus may include features, circuitry, logic, means, or instructions (e.g., a non-transitory computer-readable medium storing instructions executable by a processor) for receiving, at a computing system implementing a LLM and associated with an organization, a data set associated with one or more projects of the organization, determining, using an API library to provide the data set to the LLM, one or more tasks associated with each of the one or more projects, selecting one or more software agents for executing the one or more tasks based on determining the one or more tasks, the one or more software agents managed by the organization and selected from a database, where each software agent of the one or more software agents is configured for a respective type of tasks associated with the one or more tasks, and executing the one or more tasks using the selected one or more software agents.

Some examples of the method 500 and the apparatus described herein may further include operations, features, means, or instructions for identifying the respective type of task associated with each task of the one or more tasks using a software orchestrator of the computing system, where selecting the one or more software agents includes associating each task of the one or more tasks with a respective software agent of the one or more software agents based on the type of task associated with each task.

Some examples of the method 500 and the apparatus described herein may further include operations, features, means, or instructions for storing metadata associated with the one or more projects to a database managed by the computing system.

In some examples of the method 500 and the apparatus described herein, the data set includes a transcript of a meeting and determining the one or more tasks includes identifying the one or more tasks within the transcript using the LLM.

Some examples of the method 500 and the apparatus described herein may further include operations, features, means, or instructions for identifying, using the LLM, a first project of the one or more projects and a second project of the one or more projects and associating, using the LLM, a first subset of the one or more tasks with the first project and a second subset of the one or more tasks with the second project.

Some examples of the method 500 and the apparatus described herein may further include operations, features, means, or instructions for determining, using the LLM, that a first representative of one or more representatives associated with the meeting corresponds to a first task of the one or more tasks, determining, using the LLM, that a second representative of the one or more representatives corresponds to a second task of the one or more tasks, and storing an indication that the first representative corresponds to the first task and the second representative corresponds to the second task based on the first representative corresponding to the first task and the second representative corresponding to the second task.

In some examples of the method 500 and the apparatus described herein, executing the one or more tasks may include operations, features, circuitry, logic, means, or instructions for transmitting, using a software agent of the one or more software agents, a first message associated with the first task to the first representative and a second message associated with the second task to the second representative, refraining from transmitting the second message to the first representative, and refraining from transmitting the first message to the second representative.

In some examples of the method 500 and the apparatus described herein, the data set includes a transcript of an interaction between a representative of the organization and a user of the organization and determining the one or more tasks includes identifying one or more updates to an account managed by the organization and associated with the user.

Some examples of the method 500 and the apparatus described herein may further include operations, features, means, or instructions for providing, by the computing system, an indication of the one or more updates to a software agent of the one or more software agents and updating, by the software agent, one or more parameters of the account based on the indication of the one or more updates.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, at a computing system implementing a large language model and associated with an organization, a data set associated with one or more projects of the organization;
determining, using an application programming interface (API) library to provide the data set to the large language model, one or more tasks associated with each of the one or more projects;
selecting one or more software agents for executing the one or more tasks based at least in part on determining the one or more tasks, the one or more software agents managed by the organization and selected from a database, wherein each software agent of the one or more software agents is configured for a respective type of tasks associated with the one or more tasks; and
executing the one or more tasks using the selected one or more software agents.

2. The method of claim 1, further comprising:
identifying the respective type of task associated with each task of the one or more tasks using a software orchestrator of the computing system, wherein selecting the one or more software agents comprises associating each task of the one or more tasks with a respective software agent of the one or more software agents based at least in part on the respective type of task associated with each task.

3. The method of claim 1, further comprising:
storing metadata associated with the one or more projects to a database managed by the computing system.

4. The method of claim 1, wherein the data set comprises a transcript of a meeting, and determining the one or more tasks comprises identifying the one or more tasks within the transcript using the large language model.

5. The method of claim 4, further comprising:
identifying, using the large language model, a first project of the one or more projects and a second project of the one or more projects; and
associating, using the large language model, a first subset of the one or more tasks with the first project and a second subset of the one or more tasks with the second project.

6. The method of claim 4, further comprising:
determining, using the large language model, that a first representative of one or more representatives associated with the meeting corresponds to a first task of the one or more tasks;
determining, using the large language model, that a second representative of the one or more representatives corresponds to a second task of the one or more tasks; and
storing an indication that the first representative corresponds to the first task and the second representative corresponds to the second task based at least in part on the first representative corresponding to the first task and the second representative corresponding to the second task.

7. The method of claim 6, wherein executing the one or more tasks comprises:
transmitting, using a software agent of the one or more software agents, a first message associated with the first task to the first representative and a second message associated with the second task to the second representative;
refraining from transmitting the second message to the first representative; and
refraining from transmitting the first message to the second representative.

8. The method of claim 1, wherein the data set comprises a transcript of an interaction between a representative of the organization and a user of the organization, and determining the one or more tasks comprises identifying one or more updates to an account managed by the organization and associated with the user.

9. The method of claim 8, further comprising:
providing, by the computing system, an indication of the one or more updates to a software agent of the one or more software agents; and
updating, by the software agent, one or more parameters of the account based at least in part on the indication of the one or more updates.

10. A non-transitory computer-readable medium storing code, the code comprising instructions executable by one or more processors to:
receive, at a computing system implementing a large language model and associated with an organization, a data set associated with one or more projects of the organization;
determine, using an application programming interface (API) library to provide the data set to the large language model, one or more tasks associated with each of the one or more projects;
select one or more software agents for executing the one or more tasks based at least in part on determining the one or more tasks, the one or more software agents managed by the organization and selected from a database, wherein each software agent of the one or more software agents is configured for a respective type of tasks associated with the one or more tasks; and
execute the one or more tasks using the selected one or more software agents.

11. The non-transitory computer-readable medium of claim 10, wherein the instructions are further executable by the one or more processors to:
identify the respective type of task associated with each task of the one or more tasks using a software orchestrator of the computing system, wherein selecting the one or more software agents comprises associating each task of the one or more tasks with a respective software agent of the one or more software agents based at least in part on the respective type of task associated with each task.

12. The non-transitory computer-readable medium of claim 10, wherein the instructions are further executable by the one or more processors to:
store metadata associated with the one or more projects to a database managed by the computing system.

13. The non-transitory computer-readable medium of claim 10, wherein the data set comprises a transcript of a meeting, and wherein, to determine the one or more tasks, the instructions are further executable by the one or more processors to identifying the one or more tasks within the transcript using the large language model.

14. The non-transitory computer-readable medium of claim 13, wherein
the instructions are further executable by the one or more processors to:
identify, using the large language model, a first project of the one or more projects and a second project of the one or more projects; and
associate, using the large language model, a first subset of the one or more tasks with the first project and a second subset of the one or more tasks with the second project.

15. The non-transitory computer-readable medium of claim 13, wherein the instructions are further executable by the one or more processors to:
determine, using the large language model, that a first representative of one or more representatives associated with the meeting corresponds to a first task of the one or more tasks;
determine, using the large language model, that a second representative of the one or more representatives corresponds to a second task of the one or more tasks; and
store an indication that the first representative corresponds to the first task and the second representative corresponds to the second task based at least in part on the first representative corresponding to the first task and the second representative corresponding to the second task.

16. The non-transitory computer-readable medium of claim 15, wherein the instructions to execute the one or more tasks are executable by the one or more processors to:
transmit, using a software agent of the one or more software agents, a first message associated with the first task to the first representative and a second message associated with the second task to the second representative;
refrain from transmitting the second message to the first representative; and
refrain from transmitting the first message to the second representative.

17. The non-transitory computer-readable medium of claim 10, wherein the data set comprises a transcript of an interaction between a representative of the organization and a user of the organization, and wherein, to determine the one or more tasks, the instructions are further executable by the one or more processors to identify one or more updates to an account managed by the organization and associated with the user.

18. The non-transitory computer-readable medium of claim 17, wherein the instructions are further executable by the one or more processors to:
provide, by the computing system, an indication of the one or more updates to a software agent of the one or more software agents; and
update, by the software agent, one or more parameters of the account based at least in part on the indication of the one or more updates.

19. An apparatus, comprising:
one or more memories; and
one or more processors coupled with the one or more memories and configured to cause the apparatus to:
receive, at a computing system implementing a large language model and associated with an organization, a data set associated with one or more projects of the organization;
determine, using an application programming interface (API) library to provide the data set to the large language model, one or more tasks associated with each of the one or more projects;
select one or more software agents for executing the one or more tasks based at least in part on determining the one or more tasks, the one or more software agents managed by the organization and selected from a database, wherein each software agent of the one or more software agents is configured for a respective type of tasks associated with the one or more tasks; and
execute the one or more tasks using the selected one or more software agents.

20. The apparatus of claim 19, wherein the one or more processors are further configured to cause the apparatus to:
identify the respective type of task associated with each task of the one or more tasks using a software orchestrator of the computing system, wherein selecting the one or more software agents comprises associating each task of the one or more tasks with a respective software agent of the one or more software agents based at least in part on the respective type of task associated with each task.
